(19) United States
(12) Patent Application Publication
(10) Pub. No.: US 2023/0114776 A1
(43) Pub. Date: Apr. 13, 2023

(54) IMAGE RECOGNITION SYSTEM, IMAGE RECOGNITION METHOD, AND NON-TRANSITORY COMPUTERREADABLE MEDIUM

(71) Applicant: NEC CORPORATION, Minato-ku, Tokyo (JP)

(72) Inventor: Yasufumi HIRAKAWA, Tokyo (JP)

(73) Assignee: NEC Corporation, Minato-ku- Tokyo (JP)

(21) Appl. No.: 17/907,764

(22) PCT Filed: Mar. 27, 2020
(86) PCT No.: PCT/JP2020/013931

§ 371 Date: Aug. 29, 2022

(51) Int. Cl. G06V 10/26; G06V 40/10; G06V 10/22

(52) U.S. Cl. CPC G06V 10/267; G06V 40/10; G06V 10/22; G06V 2201/07; G06V 10/82

(57) ABSTRACT

An image recognition system includes a first detection unit, an extracted image generation unit, and a second detection unit. The first detection unit detects a person region showing at least part of a body of a person from a first image where a target object related to the person is captured. The extracted image generation unit cuts out an extracted region defined according to the person region from the first image. The second detection unit detects the target object on the basis of the cutout extracted region.

### TECHNICAL FIELD

The present disclosure relates to an image recognition system, an image recognition method, and a non-transitory computer readable medium.

### BACKGROUND ART

Techniques of detecting an object from a captured image generated by a camera are known. For example, Patent Literature 1 discloses an information processing device that detects personal belongings such as a bag of a person in a captured image by using a learned convolutional neural network (CNN).

### CITATION LIST

### Patent Literature

PTL1: International Patent Publication No. WO2019/207721

### SUMMARY OF INVENTION

### Technical Problem

A captured image generated by a camera is reduced to a predetermined image size by narrowing conversion and input to an input layer of the learned CNN. When, however, personal belongings to be detected are shown at a small size in the captured image or personal belongings to be detected have a narrow shape such as a white cane, a pixel can collapse in an image region showing the personal belongings due to narrowing conversion. In such a case, the above-described information processing device disclosed in Patent Literature 1 fails to detect personal belongings, and therefore further improvement in the accuracy of recognizing an object is needed.

In view of the foregoing, an object of the present invention is to provide an image recognition system, an image recognition method, and a non-transitory computer readable medium capable of improving the accuracy of recognizing an object in an image.

### Solution to Problem

An image recognition system according to one aspect of the present disclosure includes a first detection unit, an extracted image generation unit, and a second detection unit. The first detection unit detects a person region showing at least part of a body of a person from a first image where a target object related to the person is captured. The extracted image generation unit cuts out, from the first image, an extracted region defined according to the person region. The second detection unit detects the target object on the basis of the cutout extracted region.

An image recognition method according to one aspect of the present disclosure includes a first detection step, an extracted image generation step, and a second detection step. The first detection step detects a person region showing at least part of a body of a person from a first image where a target object related to the person is captured. The extracted image generation step cuts out, from the first image, an extracted region defined according to the person region. The second detection step detects the target object on the basis of the cutout extracted region.

A non-transitory computer readable medium according to one aspect of the present disclosure stores an image recognition program causing a computer to execute an image recognition method. The image recognition method includes a first detection step, an extracted image generation step, and a second detection step. The first detection step detects a person region showing at least part of a body of a person from a first image where a target object related to the person is captured. The extracted image generation step cuts out, from the first image, an extracted region defined according to the person region. The second detection step detects the target object on the basis of the cutout extracted region.

### Advantageous Effects of Invention

According to the present disclosure, there are provided an image recognition system, an image recognition method, and a non-transitory computer readable medium capable of improving the accuracy of recognizing an object in an image.

### BRIEF DESCRIPTION OF DRAWINGS

FIG. 1 is a block diagram showing the configuration of an image recognition system according to a first example embodiment.

FIG. 2 is a block diagram showing the configuration of an image recognition system according to a second example embodiment.

FIG. 3 is a flowchart showing a process of the image recognition system according to the second example embodiment.

FIG. 4 is a view illustrating a process of the image recognition system according to the second example embodiment.

FIG. 5 is a view illustrating a process of the image recognition system according to the second example embodiment.

FIG. 6 is a view illustrating a process of the image recognition system according to the second example embodiment.

FIG. 7 is a view illustrating a process of the image recognition system according to the second example embodiment.

FIG. 8 is a view illustrating a process of the image recognition system according to the second example embodiment.

FIG. 9 is a view showing an example of display of the image recognition system according to the second example embodiment.

FIG. 10 is a block diagram showing the configuration of an image recognition system according to a third example embodiment.

FIG. 11 is a flowchart showing a process of the image recognition system according to the third example embodiment.

FIG. 12 is a block diagram showing the configuration of an image recognition system according to a fourth example embodiment.

FIG. 13 is a flowchart showing a process of the image recognition system according to the fourth example embodiment.

FIG. 14 is a block diagram showing the configuration of an image recognition system according to a fifth example embodiment.

FIG. 15 is a flowchart showing an object region detection process of a second detection unit according to the fifth example embodiment.

FIG. 16 is a view illustrating the object region detection process of the second detection unit according to the fifth example embodiment.

FIG. 17 is a block diagram showing the configuration of an image recognition system according to a sixth example embodiment.

FIG. 18 is a flowchart showing a person region detection process of a first detection unit according to the sixth example embodiment.

FIG. 19 is a view illustrating the person region detection process of the first detection unit according to the sixth example embodiment.

FIG. 20 is a block diagram showing the configuration of an image recognition system according to a seventh example embodiment.

FIG. 21 is a view showing an example of a data structure of body part selection information according to the seventh example embodiment.

FIG. 22 is a flowchart showing a person region detection process of a first detection unit according to the seventh example embodiment.

FIG. 23 is a schematic diagram of a computer according to the first to seventh example embodiments.

### EXAMPLE EMBODIMENT

Although the present disclosure will be described hereinafter through example embodiments, the disclosure according to the claims is not limited to the following example embodiments. Further, not all of the structures described in the example embodiments are necessarily essential as means for solving the problem. In the figures, the identical reference symbols denote identical structural elements and the redundant explanation thereof is omitted according to need. In the following description, when the number of pixels (which is also called the image size) of an image or the number of pixels of an image region is denoted as X×Y, it is assumed that X indicates the number of pixels in the width direction in a rectangular image or a rectangular image region, and Y indicates the number of pixels in the height direction in a rectangular image or a rectangular image region. It is also assumed that X and Y are natural numbers.

### First Example Embodiment

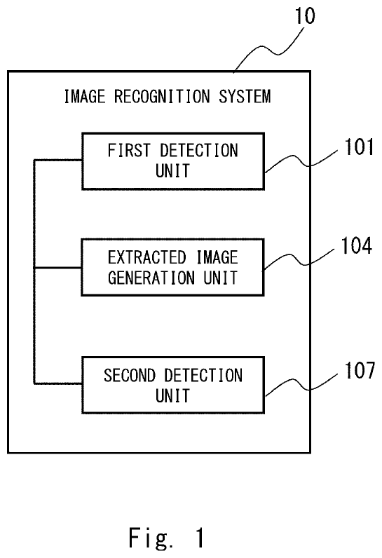

A first example embodiment of the present disclosure will be described hereinafter with reference to FIG. 1. FIG. 1 is a block diagram showing the configuration of an image recognition system 10 according to the first example embodiment. The image recognition system 10 includes a first detection unit 101, an extracted image generation unit 104, and a second detection unit 107. The first detection unit 101 detects a person region showing at least part of a body of a person from a first image where a target object related to the person is captured.

The extracted image generation unit 104 cuts out an extracted region that is defined according to the person region from the first image.

The second detection unit 107 detects the target object on the basis of the cutout extracted region.

As described above, in the configuration of the first example embodiment, the image recognition system 10 detects a target object on the basis of an extracted region excluding an unnecessary region. This avoids pixel collapse from occurring in an image region showing the target object when converting a subject image into an image size equal to the image size of an input image of CNN in order to detect the target object. The accuracy of recognizing an object in an image is thereby improved.

### Second Example Embodiment

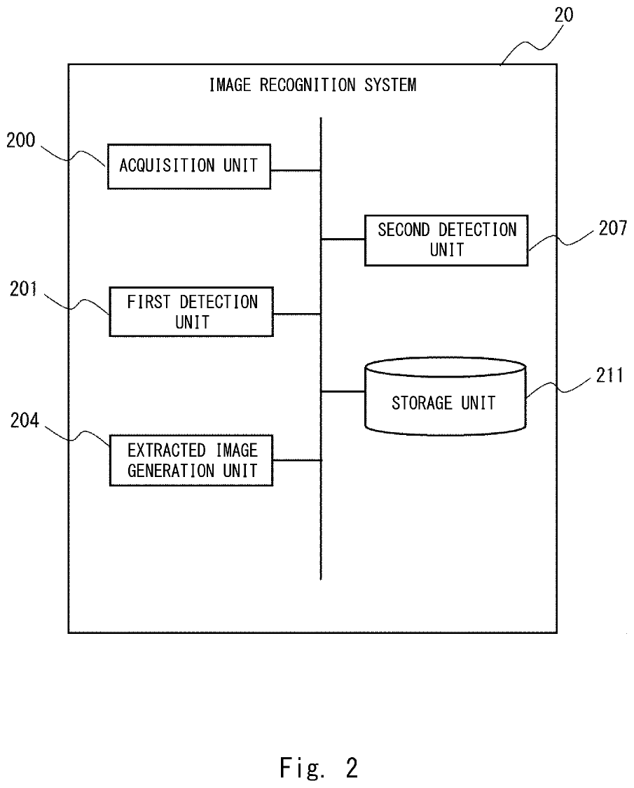

A second example embodiment of the present disclosure will be described hereinafter with reference to FIGS. 2 to 9. FIG. 2 is a block diagram showing the configuration of an image recognition system 20 according to the second example embodiment. The image recognition system 20 is a computer system that recognizes a target object related to a person from a captured image.

The image recognition system 20 includes an acquisition unit 200, a first detection unit 201, an extracted image generation unit 204, a second detection unit 207, and a storage unit 211.

The acquisition unit 200 acquires various information required for a sequence of recognition process such as detection of a target object. The acquisition unit 200 acquires a first image I1 from an imaging device (not shown) such as a monitoring camera or by receiving input from a user. In the first image I1, a person and a target object related to the person are captured. The target object may be a person's personal belongings. The person's personal belongings are not limited to objects held in the person's hand but include objects possessed in any way. A person's personal belongings may be an object held in the person's hand (white cane, bag, etc.), an object hanged from the person's neck (identification card etc.), an object worn on the person's head (hat etc.), or an object worn on the person's face (glasses etc.). The acquisition unit 200 supplies the acquired information to the first detection unit 201.

The first detection unit 201 detects, from the first image I1, a person region showing at least part of a body of a person by using a person region detector. The person region may show the entire person or one part of the body of the person. In an example, one part of a person's body is a body part such as hand, arm, neck, head or face. The person region detector may be a detector that has previously learned so as to detect an image region showing a person or an image region showing a specific body part of a person from an input image, for example. For the detector, any existing object detection model may be used. In this second example embodiment, a detection model such as SSD (Single Shot MultiBox Detector) or WSSD (Weighted Single Shot MultiBox Detector) including learned CNN is used for the person region detector. It is, however, not limited thereto, and another any detection model such as SVM (Support Vector Machine) may be used.

The first detection unit 201 supplies information of the detected person region to the extracted image generation unit 204.

The extracted image generation unit 204 cuts out an extracted region from the first image I1. The extracted region is an image region that is defined according to the person region detected by the first detection unit 201. For example, the extracted region may be an image region that is placed at a predetermined position relative to the person region and over a predetermined range in the first image I1. Further, the extracted region may be an image region that is placed over a predetermined range, with its center being the person region, in the first image I1. In an example, the extracted region may be an image region having the number of pixels that is set on the basis of the number of pixels of the person region, whose center corresponds to the center of the person region, in the first image I1. Further, the extracted region may be the same image region as the person region.

Then, the extracted image generation unit 204 generates a second image 12 on the basis of the cutout extracted region. The extracted image generation unit 204 generates the second image I2 by performing image conversion of the extracted region so that the extracted region becomes the same image size as an input image of an object detector used in the second detection unit 207, which is described later.

The extracted image generation unit 204 supplies the generated second image I2 to the second detection unit 207.

The second detection unit 207 detects an object region, which is an image region showing a target object, from the second image I2 by using an object detector. The object detector may be a detector that has previously learned so as to detect an image region showing a target object from an input image. For the object detector, a detection model such as SSD or WSSD including learned CNN may be used.

The storage unit 211 is a storage medium that stores various information required for a sequence of recognition process such as detection of a target object. For example, the storage unit 211 stores learned parameters of the person region detector to be used by the first detection unit 201, learned parameters of the object detector to be used by the second detection unit 207 and the like.

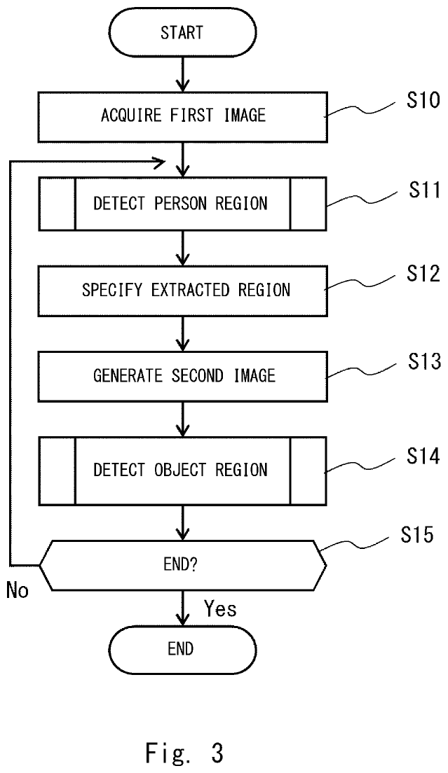

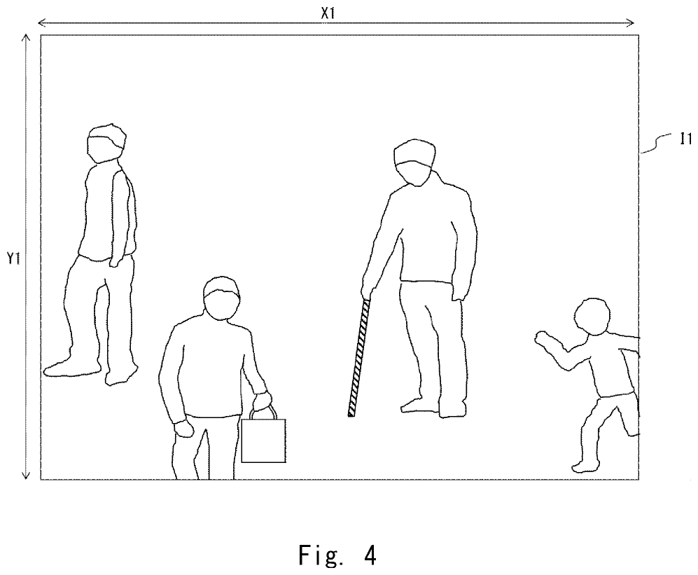

An image recognition method of the image recognition system 20 is described hereinafter with reference to FIGS. 3 and also to 4 to 8. FIG. 3 is a flowchart showing a process of the image recognition system 20 according to the second example embodiment. FIGS. 4 to 8 are views illustrating the process of the image recognition system 20 according to the second example embodiment.

First, in Step S10, the acquisition unit 200 acquires the first image I1. In the first image I1, persons and target objects related to the persons are captured as shown in FIG. 4. In this example, the target object is a “white cane” that is held in one person's hand. As shown in FIG. 4, the first image I1 has the number of pixels X1×Y1. In this example, the first image I1 is a full high definition captured image where X1 is 1920 and Y1 is 1080.

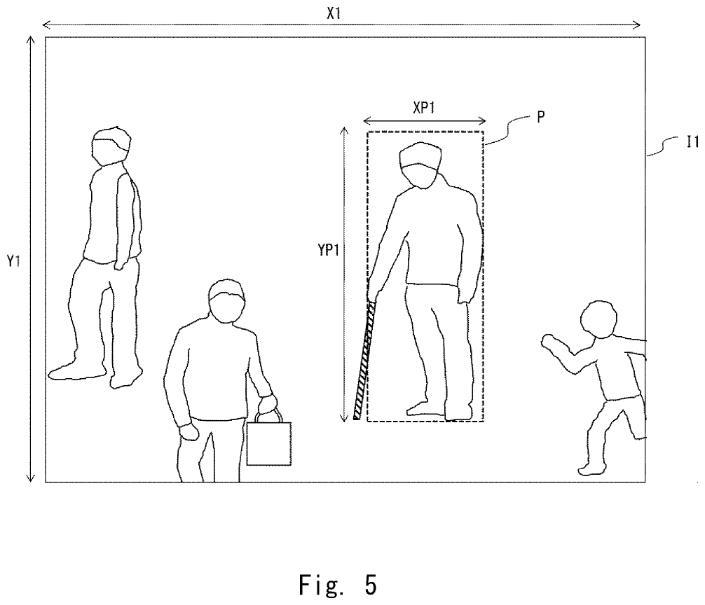

Next, in Step S11, the first detection unit 201 detects a person region from the first image I1. In this example, the first detection unit 201 detects a person region P, which is the entire person, from the first image I1 by acquiring a learned parameter of the person region detector from the storage unit 211 and using the learned person region detector containing this learned parameter. As shown in FIG. 5, the person region P has the number of pixels XP1×YP1 (XP1<X1 and YP1<Y1).

At this time, the first detection unit 201 may convert the first image I1 so that an image size is equal to the image size (e.g., 300×300) of an input image of the person region detector and input the converted image to the person region detector. Then, the first detection unit 201 may specify the person region P in the first image I1 on the basis of the image region relevant to an output result. Note that, when performing image conversion, the first detection unit 201 may perform the same processing as image conversion performed by the extracted image generation unit 204 in Step S13, which is described later.

Then, the first detection unit 201 supplies information about the person region P to the extracted image generation unit 204.

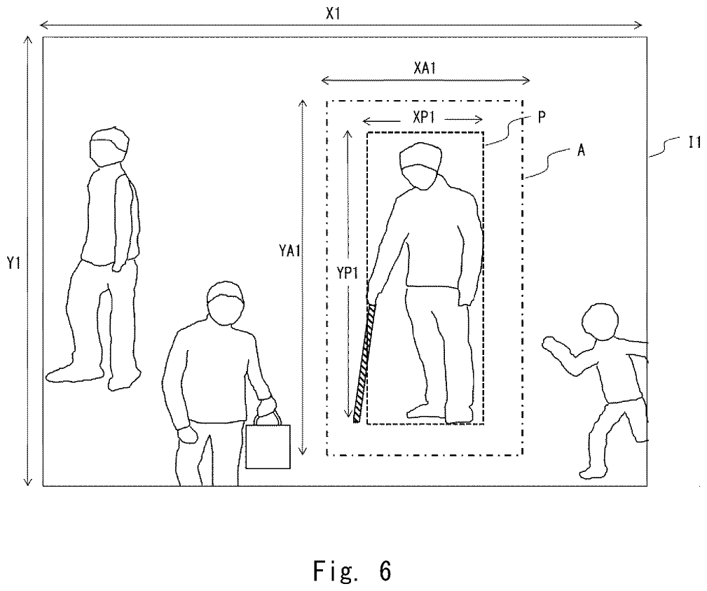

Then, in Step S12, the extracted image generation unit 204 specifies an extracted region on the basis of the person region. For example, as shown in FIG. 6, the extracted image generation unit 204 specifies, as an extracted region A, an image region having the number of pixels XA1×YA1 (XP1<XA1<X1 and YP1<YA1<Y1), whose center corresponds to the center of the person region P. Each of XA1 and YA1 may be set on the basis of XP1 and YP1, respectively. For example, each of XA1 and YA1 may have a value that is N (N>1) times XP1 and YP1, and N may be previously determined.

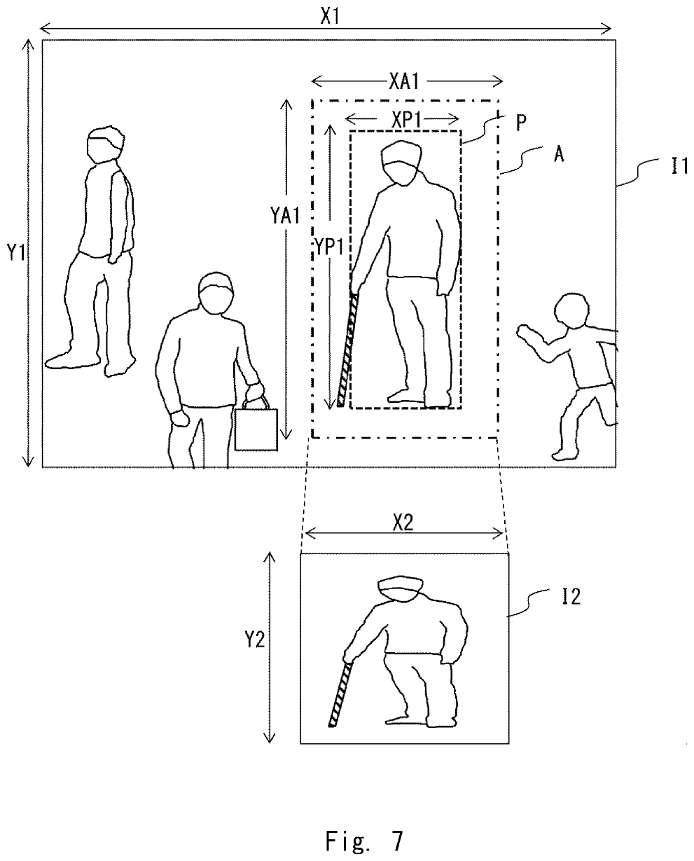

In Step S13, the extracted image generation unit 204 generates the second image I2 on the basis of the specified extracted region. For example, as shown in FIG. 7, the extracted image generation unit 204 cuts out the extracted region A having the number of pixels XA1×YA1 from the first image I1, and converts the extracted region A into the second image I2 having the number of pixels X2×Y2. X2 and Y2 are equal to the number of pixels in the width direction and the number of pixels in the height direction of the image size of an input image of the object detector, respectively. X2 and Y2 may be smaller values than X1 and Y1, respectively. In this example, X2 and Y2 are both 300.

At this time, the extracted image generation unit 204 performs image conversion such as enlargement, reduction, extension or compression on the extracted region A on the basis of the number of pixels of the extracted region A and the second image I2. In this example, the extracted image generation unit 204 performs image conversion that is (X2/XA1) times in the width direction and (Y2/YA1) times in the height direction on the extracted region A. For example, when enlarging or reducing the extracted region A, the extracted image generation unit 204 may change the interval between a predetermined pixel included in the extracted region A and an adjacent pixel and interpolate a pixel between them. Further, when extending the extracted region A, the extracted image generation unit 204 may increase the interval between pixels in the extending direction and interpolate a pixel between them. Further, when compressing the extracted region A, the extracted image generation unit 204 may reduce the interval between pixels in the narrowing direction and interpolate a pixel according to need. When enlarging or extending the extracted region A, the extracted image generation unit 204 may perform zero padding in the enlarging or extending direction instead of increasing the interval between pixels.

Then, the extracted image generation unit 204 supplies the generated second image I2 to the second detection unit 207.

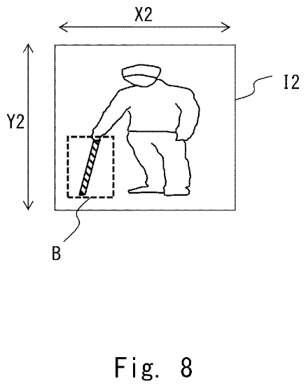

In Step S14, the second detection unit 207 acquires a learned parameter of the object detector from the storage unit 211, and detects an object region from the second image I2 by using the learned object detector containing this learned parameter. As described above, the image size of an input image of the object detector is equal to X2×Y2. Thus, this image size is 300×300 in this example. As shown in FIG. 8, for example, the second detection unit 207 detects the object region B showing a white cane in the second image I2.

Then, in Step S15, the second detection unit 207 determines whether or not to end the process. The second detection unit 207 ends the process when it determines to end it, and otherwise returns the process to Step S11. In the case of not performing Steps S11 to S13 as in the information processing device described in Patent Literature 1, the first image I1 that is reduced from X1×Y1 (=1920×1080) to X2×Y2 (=300×300) is input as the second image I2 to the object detector. Specifically, the first image I1 is reduced so that the number of pixels in the width direction becomes (X2/X1) (=approximately 0.16) times larger, and the number of pixels in the height direction becomes (Y2/Y1) (=approximately 0.28) times larger. When the proportion of the resolution of the image after conversion to that of the image before conversion is S, S in the width direction is (X2/X1) (=approximately 0.16), S in the height direction is (Y2/Y1) (=approximately 0.28), and therefore the resolution of the image significantly decreases due to the image conversion. This can cause the occurrence of pixel collapse in the object region in the second image I2. On the other hand, according to the second example embodiment, since the extracted region A cut out in Steps S11 to S13 is converted into the second image I2, a decrease in the resolution caused by image conversion is reduced as the number of pixels of the extracted region A becomes closer to the number of pixels of the second image I2. For example, when the number of pixels of the extracted region A is equal to X2×Y2 (=300×300), the resolution of the generated second image I2 remains approximately the same as the resolution of the extracted region A in the first image IL This prevents the occurrence of pixel collapse in the object region, and thereby improves the accuracy of recognizing a target object in the first image I1. Further, since information about an unnecessary region in the first image I1 is removed in the extracted region A, the accuracy of recognition is improved at low cost. The image recognition system 20 according to the second example embodiment has particularly advantageous effects when the target object is a “white cane” where the number of pixels in one of the width and height directions is significantly smaller than the number of pixels in the other direction. Therefore, the image recognition system 20 is applicable to an audio support system or the like that specifies a person with low vision who has a “white cane” by using a video of a monitoring camera, and provides the specified person with audio guidance. Although the image size of an input image of the object detector is 300×300, i.e., X2 and Y2 are both 300, in the second example embodiment, X2 and Y2 may be both less than 300. Specifically, the image size of an input image of the object detector may be 200×200, 150×150, or 100×100. In this case, the object detector may be a detector that has learned according to an input image with a predetermined image size. Note that, however, when the image size of an input image of the object detector is such a small value, the resolution of the generated second image I2 decreases compared with the case of 300x300. However, even in this case, by setting X2 and Y2 so that the proportion S of the resolution of images before and after conversion is greater than S when detecting the object region without performing Steps S11 to S13, the effect of a decrease in resolution on the accuracy of recognition is reduced. Further, in this case, the second detection unit 207 can detect the object region by using a lighter weight detector, which significantly reduces the computational cost while maintaining a certain level of recognition accuracy.

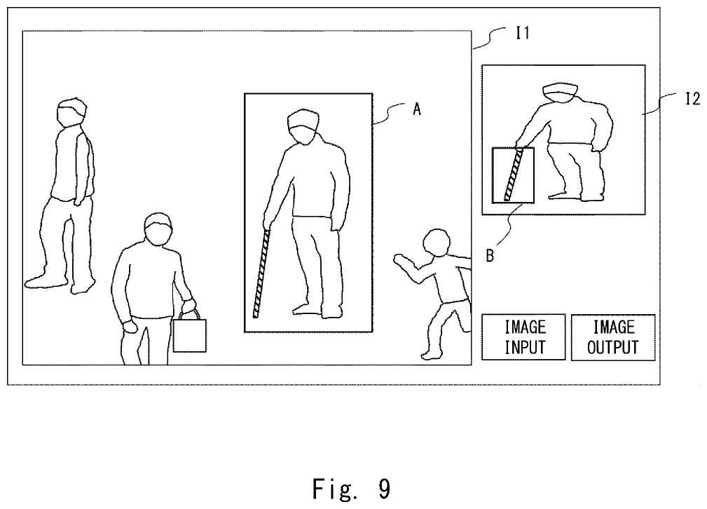

Note that the image recognition system 20 according to the second example embodiment may further include a display unit. FIG. 9 is a view showing an example of display of the image recognition system 20 according to the second example embodiment. As shown in this figure, the display unit may display the first image I1 and the second image I2.

The display unit may display the object region B superimposed on the second image I2 in response to detection of the object region B from the second image I2.

Further, the display unit may display the extracted region A corresponding to the detected the object region B superimposed on the first image I1

Further, as shown in the figure, the display unit may include an image input means that receives input of the first image I1 from a user. The image input means may be connected to the acquisition unit 200. Then, the display unit may display the first image I1 when the image input means receives input of the first image I1.

The display unit may include an image output means that receives, from a user, a request for outputting the first image I1 on which the extracted region A is displayed superimposed, and the second image or the second image I2 on which the object region B is displayed superimposed. The image recognition system 20 may output the requested image data in a predetermined data format in response to receiving a request for the output by the image output means.

### Third Example Embodiment

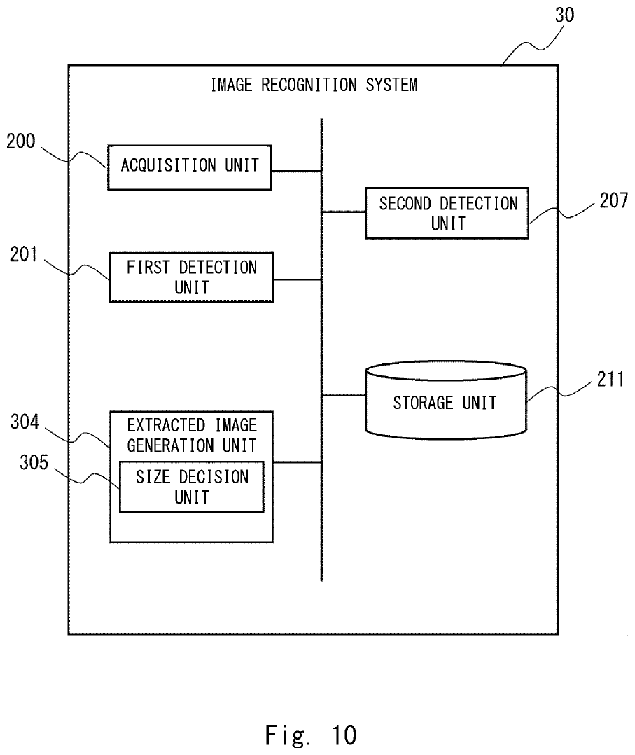

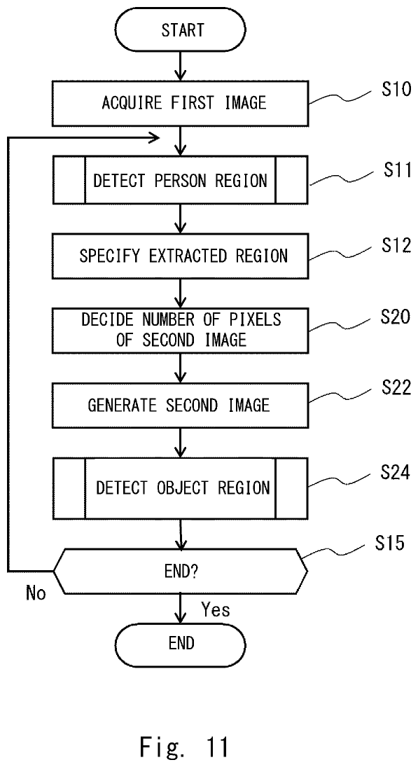

A third example embodiment of the present disclosure will be described hereinafter with reference to FIGS. 10 and 11. The third example embodiment is characterized in that the image size of the second image I2 is decided on the basis of the size of the extracted region.

FIG. 10 is a block diagram showing the configuration of an image recognition system 30 according to the third example embodiment. The image recognition system 30 of the third example embodiment has basically similar configuration and functions to the image recognition system 20 of the second example embodiment. Note that, however, the image recognition system 30 of the third example embodiment is different from the second example embodiment in that it includes an extracted image generation unit 304 in place of the extracted image generation unit 204.

The extracted image generation unit 304 includes a size decision unit 305 in addition to the configuration and functions of the extracted image generation unit 204.

The size decision unit 305 decides the number of pixels of the second image I2 on the basis of the number of pixels of the extracted region. For example, the size decision unit 305 selects one of the predetermined numbers of pixels which the second image I2 can have on the basis of the number of pixels of the extracted region, and decides the selected number of pixels as the number of pixels of the second image I2. The numbers of pixels which the second image I2 can have may include 300×300 and 200×200, for example. Then, the extracted image generation unit 204 converts the extracted region according to the decided number of pixels and thereby generates the second image I2.

The storage unit 211 of the third example embodiment stores a learned parameter of the object detector for each of the numbers of pixels which the second image I2 can have, in addition to information stored in the storage unit 211 of the second example embodiment. For example, the storage unit 211 stores a learned parameter of the object detector for the image size 300×300 of an input image, and a learned parameter of the object detector for the image size 200×200 of an input image.

FIG. 11 is a flowchart showing a process of the image recognition system 30 according to the third example embodiment. Steps in FIG. 11 include Steps S20 to S24 instead of Steps S13 to S14 shown in FIG. 3. Note that the same steps as the steps shown in FIG. 3 are denoted by the same reference symbols, and description thereof is omitted.

In Step S20, after the extracted region A is specified by the extracted image generation unit 304 in Step 12, the size decision unit 305 of the extracted image generation unit 304 decides the number of pixels of the second image I2 on the basis of the number of pixels of the extracted region A.

For example, when the number of pixels of the extracted region A in at least one of the height and width directions is less than 300, the size decision unit 305 may decide the number of pixels of the second image I2 as 200×200. When, on the other hand, the number of pixels of the extracted region A in both of the height and width directions is 300 or more, the size decision unit 305 may decide the number of pixels of the second image I2 as 300×300.

Further, the size decision unit 305 may decide the number of pixels of the second image I2 in such a way that the proportion S of the solution of images before and after conversion is greater than a predetermined reference value S0. The proportion S of the solution of images before and after conversion is a value obtained by dividing the number of pixels of the second image I2 by the number of pixels of the extracted region A (i.e., X2/XA1 in the width direction or Y2/YA1 in the height direction). For example, to secure the resolution of the second image I2, the size decision unit 305 decides, as the number of pixels of the second image I2, the number of pixels that is greater than the product of the number of pixels of the extracted region A and the reference value S0 among the numbers of pixels which the second image I2 can have. To be specific, the size decision unit 305 selects, from the values of X2 (or Y2) which the second image 12 can have, a value greater than the product of the smaller one of the numbers of pixels of the extracted region A in the height and width directions and the reference value S0, and decides it as X2 (or Y2) of the second image I2. When there are a plurality of values of X2 (or Y2) selected in this way, the size decision unit 305 may decide the minimum value of those values as X2 (or Y2) of the second image I2. This reduces the computational cost.

Then in Step S22, the extracted image generation unit 304 performs the same processing as in Step S13 on the basis of the specified extracted region A and the decided number of pixels of the second image I2, and thereby generates the second image I2. The extracted image generation unit 304 then supplies the generated second image I2 to the second detection unit 207.

In Step S24, the second detection unit 207 acquires a learned parameter of the object detector corresponding to the decided number of pixels of the second image I2 from the storage unit 211. Then, the second detection unit 207 detects the object region B from the second image I2 by using the learned object detector containing this learned parameter.

As described above, according to the third example embodiment, the image recognition system 30 decides the image size of the second image I2 on the basis of the size of the cutout extracted region A. This reduces the computational cost as well as securing the resolution of an input image in detection of the object region and thereby securing the accuracy of recognition.

### Fourth Example Embodiment

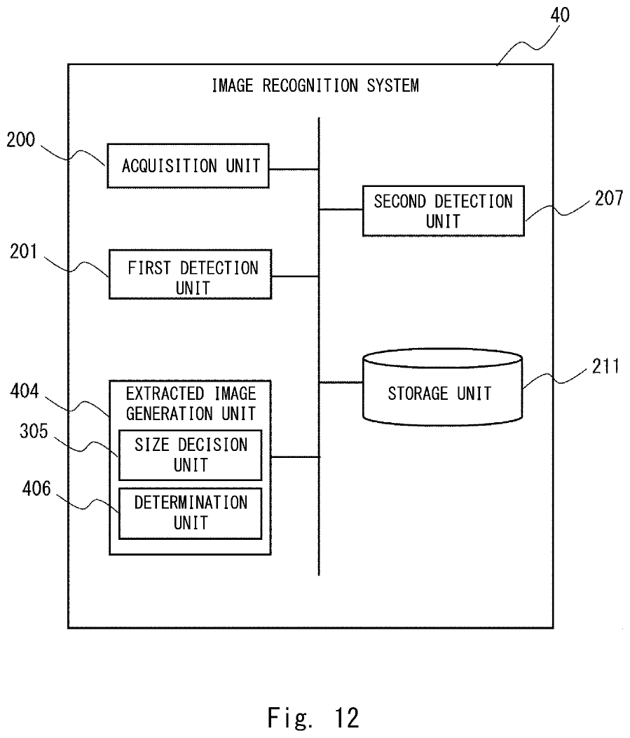

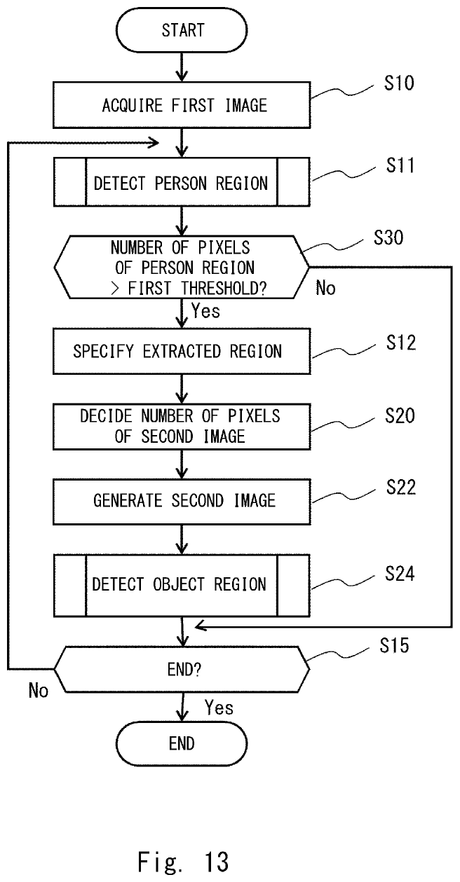

A fourth example embodiment of the present disclosure will be described hereinafter with reference to FIGS. 12 and 13. When a person is shown at a small size in the first image I1, a target object related to this person is also likely to be shown at a small size. In this case, it is difficult to accurately detect the object region of a target object. The fourth example embodiment is characterized in that, when the person region P is smaller than a predetermined size, the subsequent object region detection is not performed.

FIG. 12 is a block diagram showing the configuration of an image recognition system 40 according to the fourth example embodiment. The image recognition system 40 of the fourth example embodiment has basically similar configuration and functions to the image recognition system 30 of the third example embodiment. Note that, however, the image recognition system 40 of the fourth example embodiment is different from the third example embodiment in that it includes an extracted image generation unit 404 in place of the extracted image generation unit 304.

The extracted image generation unit 404 includes a determination unit 406 in addition to the configuration and functions of the extracted image generation unit 304.

The determination unit 406 determines whether or not to generate the second image I2 on the basis of the number of pixels of the person region P. In other words, the determination unit 406 determines whether or not to let the process proceed to the subsequent object region detection step on the basis of the number of pixels of the person region P.

FIG. 13 is a flowchart showing a process of the image recognition system 40 according to the fourth example embodiment. Steps in FIG. 13 include Step S30 in addition to the steps shown in FIG. 11. Note that the same steps as the steps shown in FIG. 11 are denoted by the same reference symbols, and description thereof is omitted.

In Step S30, after the first detection unit 201 detects the person region P from the first image I1 in Step S11, the determination unit 406 of the extracted image generation unit 404 determines whether the number of pixels of the person region P is greater than a predetermined first threshold. To be specific, the determination unit 406 determines whether the number of pixels of the person region P in the height or width direction is greater than the first threshold. When the determination unit 406 determines that this number of pixels is greater than the first threshold (Yes in Step S30), it lets the process proceed to Step S12. Otherwise (No in Step S30), the determination unit 406 lets the process proceed to Step S15.

As described above, according to the fourth example embodiment, since the image recognition system 40 determines whether to generate the second image 12 on the basis of the number of pixels of the person region P, the subsequent processing can be omitted when the person region P is less than a predetermined size. This reduces the computational cost as well as securing the real time performance of a sequence of recognition process.

Note that the determination unit 406 may determine whether to generate the second image I2 on the basis of the number of pixels of the extracted region A instead of the number of pixels of the person region P. In this case, Step S30 shown in FIG. 13 is omitted. Then, in Step S12, the extracted image generation unit 404 specifies the extracted region A on the basis of the person region P, and determines whether the number of pixels of the extracted region A is greater than the first threshold. When the determination unit 406 determines that this number of pixels is greater than the first threshold, it lets the process proceed to Step S20. Otherwise, the determination unit 406 lets the process proceed to Step S15. The same effects as above are obtained in this case also.

### Fifth Example Embodiment

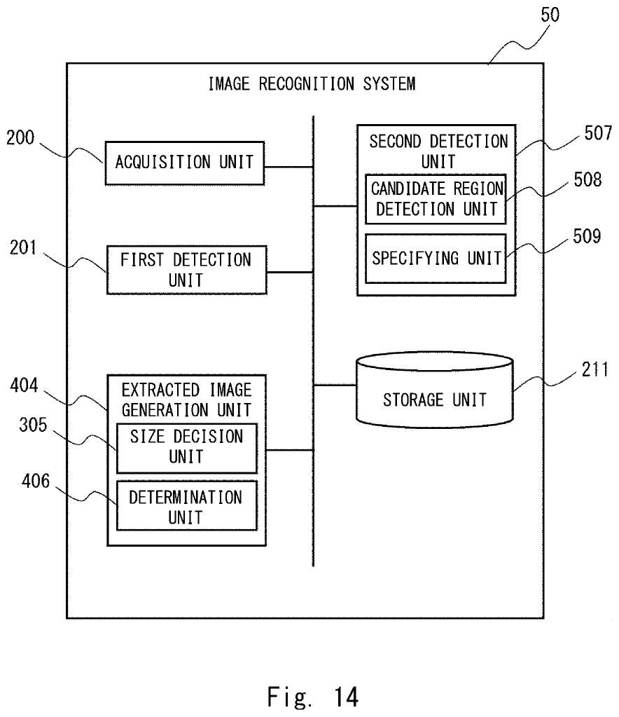

A fifth example embodiment of the present disclosure will be described hereinafter with reference to FIGS. 14 to 16. The fifth example embodiment is characterized in that the object region is specified on the basis of information on the position relative to the person region from detection results of the object detector.

FIG. 14 is a block diagram showing the configuration of an image recognition system 50 according to the fifth example embodiment. The image recognition system 50 of the fifth example embodiment has basically similar configuration and functions to the image recognition system 40 of the fourth example embodiment. Note that, however, the image recognition system 50 of the fifth example embodiment is different from the fourth example embodiment in that it includes a second detection unit 507 in place of the second detection unit 207.

The second detection unit 507 basically has similar functions to the second detection unit 207, and it further includes a candidate region detection unit 508 and a specifying unit 509.

The candidate region detection unit 508 detects one or a plurality of candidate regions from the second image I2 by using the object detector. The candidate region is an image region that is likely to show a target object.

The specifying unit 509 specifies the object region B from one or a plurality of candidate regions on the basis of relative position information of one or a plurality of candidate regions to the person region P. In this fifth example embodiment, the relative position information may be the distance between the person region P and the candidate region, for example.

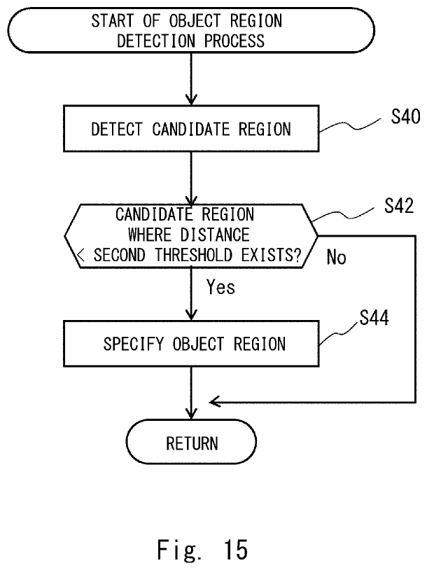

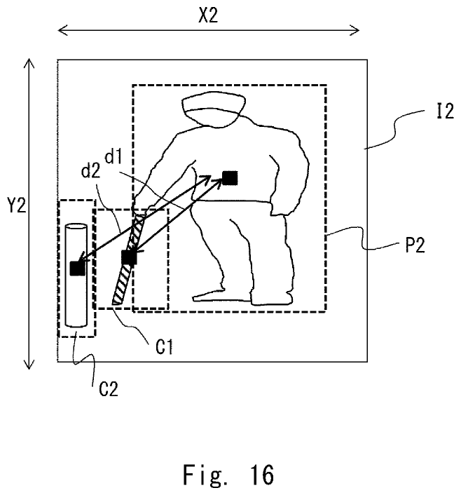

An object region detection process of the second detection unit 507 according to the fifth example embodiment is described hereinafter with reference to FIG. 15 and also to FIG. 16. FIG. 15 is a flowchart showing the object region detection process of the second detection unit 507 according to the fifth example embodiment. FIG. 16 is a view illustrating the object region detection process of the second detection unit 507 according to the fifth example embodiment.

First, in Step S40, the candidate region detection unit 508 of the second detection unit 507 acquires, from the second image I2, a learned parameter of the object detector corresponding to the number of pixels of the second image I2. Then, the candidate region detection unit 508 detects candidate regions from the storage unit 211 by using the learned object detector containing this learned parameter. As shown in FIG. 16, the candidate region detection unit 508 detects a plurality of candidate regions C1 and C2 in the second image I2.

Next, in Step S42, the specifying unit 509 calculates the distance between each of the candidate regions and a person region P2 in the second image I2. The person region P2 in the second image I2 is an image region corresponding to the person region P in the first image I1. As shown in FIG. 16, the distances d1 and d2 between each of the candidate regions C1 and C2 and the person region P2 may be the distance between a representative point such as the center of each candidate region and a representative point such as the center of the person region P2.

Then, the specifying unit 509 determines whether there is a candidate region whose distance from the person region P2 is less than a second threshold. Note that the second threshold may be a predetermined value or a value that is set according to the number of pixels of the second image I2. When the specifying unit 509 determines that there is a candidate region whose distance from the person region P2 is less than the second threshold (Yes in Step S42), it lets the process proceed to Step S44. Otherwise (No in Step S42), it returns the process to Step S15 shown in FIG. 13.

After that, in Step S44, the specifying unit 509 specifies, as the object region B, the candidate region whose distance from the person region P2 is less than the second threshold. The specifying unit 509 then returns the process to Step S15 shown in FIG. 13.

As described above, according to the fifth example embodiment, since the image recognition system 50 determines whether an object is personal belongings of a certain person on the basis of the distance from this person, a target object possessed by a person is adequately detectable, which improves the accuracy of recognition. For example, when the target object is a “white cane”, the image recognition system 50 adequately detects the white cane by using a video of a monitoring camera and further adequately specifies a person having this white cane.

Note that, in the case where the second threshold is dynamically set according to the number of pixels of the person region P2, the image recognition system 50 is capable of more adequately detecting a target object possessed by a person, which further improves the accuracy of recognition.

In the fifth example embodiment, the image recognition system 50 specifies, as the object region B, a candidate region whose distance from the person region P2 is less than the second threshold. Alternatively, the image recognition system 50 may specify, as the object region B, a candidate region whose distance from the person region P2 is shortest. This also has the same effects as described above.

### Sixth Example Embodiment

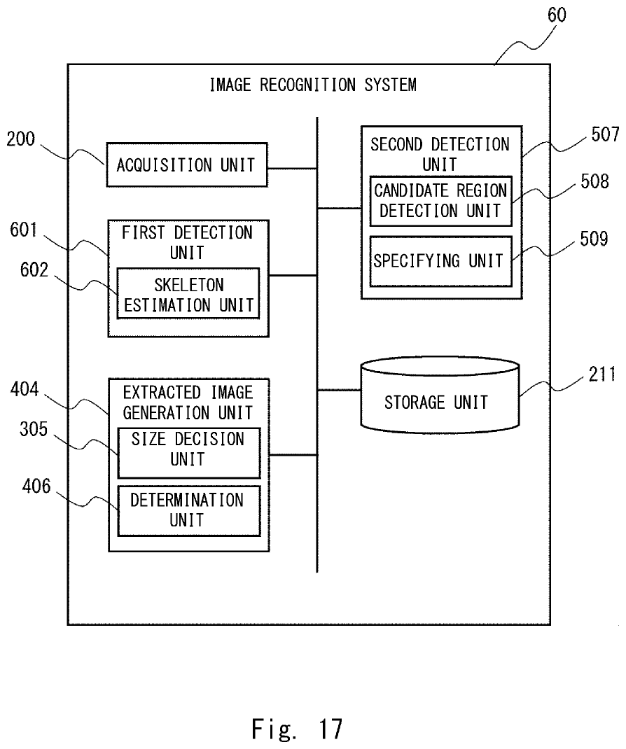

A sixth example embodiment of the present disclosure will be described hereinafter with reference to FIGS. 17 to 19. The sixth example embodiment is characterized in that the person region is detected on the basis of the skeletal structure of a person.

FIG. 17 is a block diagram showing the configuration of an image recognition system 60 according to the sixth example embodiment. The image recognition system 60 of the sixth example embodiment has basically similar configuration and functions to the image recognition system 50 of the fifth example embodiment. Note that, however, the image recognition system 60 of the sixth example embodiment is different from the fifth example embodiment in that it includes a first detection unit 601 in place of the first detection unit 201.

The first detection unit 601 basically has similar functions to the first detection unit 201, and detects a person region P from the first image I1. In this sixth example embodiment, the person region P shows a body part of a person. For example, the person region P shows a body part such as hand, neck, head or face. The first detection unit 601 includes a skeleton estimation unit 602.

The skeleton estimation unit 602 estimates a two-dimensional skeletal structure of a person by using a skeleton estimation model. Then, the skeleton estimation unit 602 detects the person region P on the basis of the estimated two-dimensional skeletal structure. The skeleton estimation model may be the existing skeleton estimation model learned by machine learning.

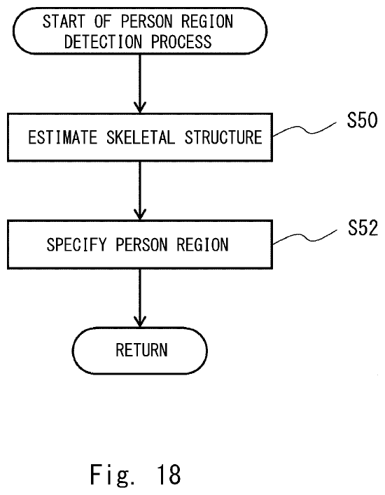

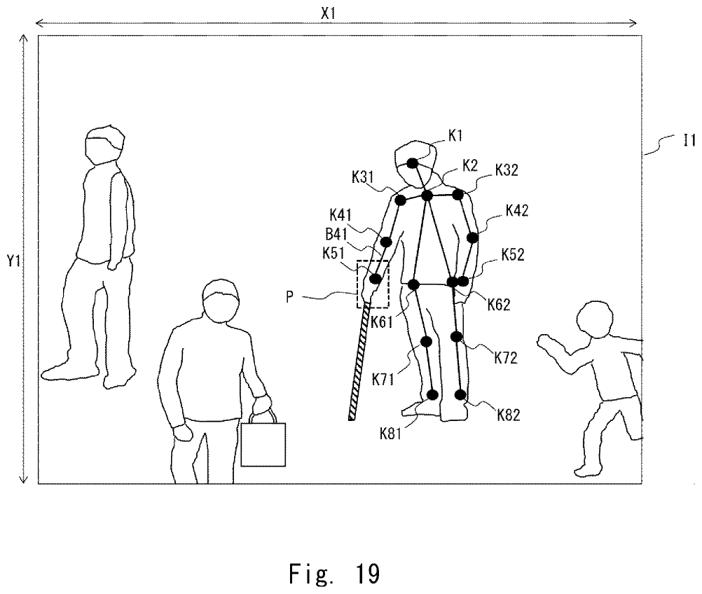

A person region detection process of the first detection unit 601 according to the sixth example embodiment is described hereinafter with reference to FIGS. 18 and also to FIG. 19. FIG. 18 is a flowchart showing the person region detection process of the first detection unit 601 according to the sixth example embodiment. FIG. 19 is a view illustrating the person region detection process of the first detection unit 601 according to the sixth example embodiment.

First, in Step S50, the skeleton estimation unit 602 of the first detection unit 601 estimates the two-dimensional skeletal structure of a person from the first image I1 by using the skeleton estimation model. The estimated two-dimensional skeletal structure is composed of key points, which are characteristic points such as joints, and bones connecting the key points. For example, the skeleton estimation unit 602 first extracts characteristic points that can be key points from the first image I1, and detects each key point of a person by referring to machine-learned information of key point images. In the example shown in FIG. 19, head K1, neck K2, right shoulder K31, left shoulder K32, right elbow K41, left elbow K42, right hand K51, left hand K52, right waist K61, left waist K62, right knee K71, left knee K72, right foot K81, and left foot K82 are detected as key points of a person.

Next, in Step S52, the skeleton estimation unit 602 specifies the person region P on the basis of the estimated two-dimensional skeletal structure. In the example shown in FIG. 19, the target object is a “white cane”, and the person region P shows the “hand” of a person. Thus, the skeleton estimation unit 602 may select the right hand K51, which is a key point related to “hand” of the person from the detected plurality of key points, and specify a region of a predetermined range including the right hand K51 as the person region P.

At this time, the skeleton estimation unit 602 may decide the range of the person region P on the basis of the length of a bone connecting key points. For example, the skeleton estimation unit 602 may decide the range of the person region P on the basis of the length of a bone B41 connecting the right hand K51 and the right elbow K41, and thereby specify the person region P.

After that, the skeleton estimation unit 602 returns the process to Step S30 shown in FIG. 13.

Note that, in Step S42 shown in FIG. 15, the specifying unit 509 may use a point corresponding to the key point selected during estimation of the person region P as a representative point of the person region P2 for calculation of the distance between a candidate region and the person region P2.

As described above, according to the sixth example embodiment, since the image recognition system 60 detects the person region on the basis of the skeletal structure of a person, it is capable of adequately detecting a target object possessed by the person on the basis of the person region, which further improves the accuracy of recognition.

### Seventh Example Embodiment

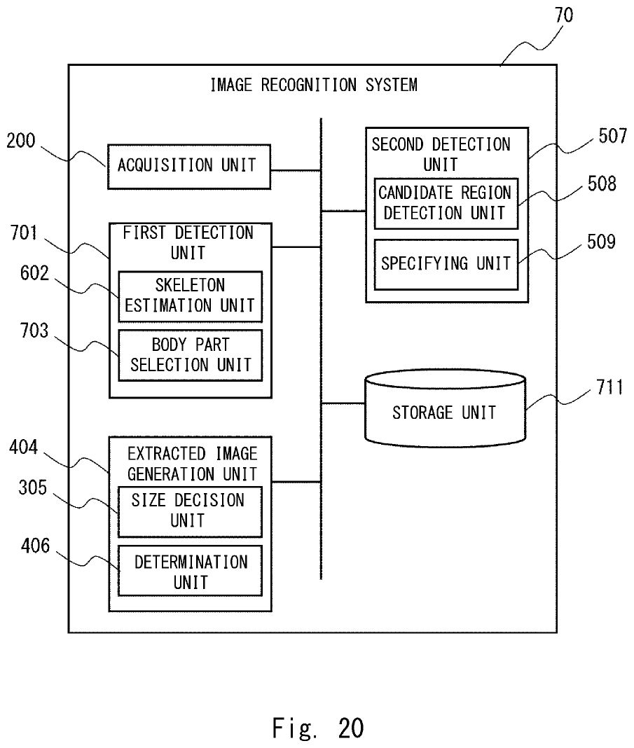

A seventh example embodiment of the present disclosure will be described hereinafter with reference to FIGS. 20 to 22. The seventh example embodiment is characterized in that the person region is specified according to the type of target object.

FIG. 20 is a block diagram showing the configuration of an image recognition system 60 according to the seventh example embodiment. The image recognition system 70 of the seventh example embodiment has basically similar configuration and functions to the image recognition system 60 of the sixth example embodiment. Note that, however, the image recognition system 70 of the seventh example embodiment is different from the sixth example embodiment in that it includes a first detection unit 701 in place of the first detection unit 601 and includes a storage unit 711 in place of the storage unit 211.

The first detection unit 701 includes a body part selection unit 703 in addition to the configuration and functions of the first detection unit 601.

The body part selection unit 703 selects the type of body part on the basis of the type of target object. Note that the skeleton estimation unit 602 specifies the person region P according to the selected type of body part.

The storage unit 711 stores body part selection information that associates the type of target object with the type of body part in addition to the configuration and functions of the storage unit 211. Further, the storage unit 711 stores a learned parameter of the person region detector for each type of body part and a learned parameter of the object detector for each type of target object.

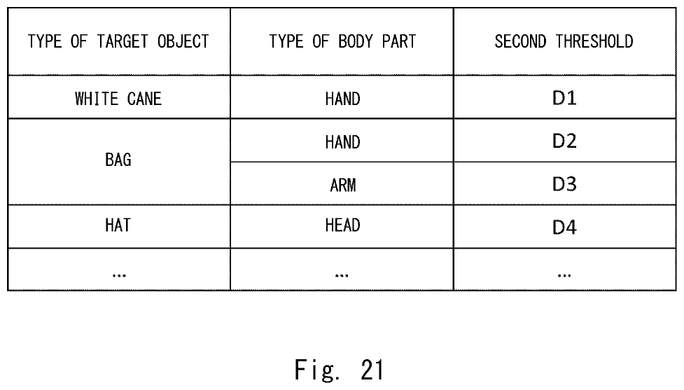

FIG. 21 is a view showing an example of the data structure of the body part selection information according to the seventh example embodiment. The body part selection information contains the type of target object and the type of body part.

The type of target object may be “white cane”, “bag”, “hat” and the like.

The type of body part may be “hand” when the type of target object is “white cane”, it may be “hand” or “arm” when the type of target object is “bag”, and it may be “head” when the type of target object is “hat”.

Note that the body part selection information may further contain a value related to the second threshold that is used when specifying the object region as shown in the figure. A value related to the second threshold contained in the body part selection information may be a value of the second threshold or a normalized value of the second threshold when the person region P2 is normalized into a predetermined size. In this case, in Step S42 shown in FIG. 15, the specifying unit 509 may acquire a value related to the second threshold from the body part selection information in the storage unit 711 on the basis of the type of target object and the type of body part, and set a value of the second threshold on the basis of this value. Then, the specifying unit 509 may determine whether there is a candidate region whose distance from the person region P2 is less than the second threshold.

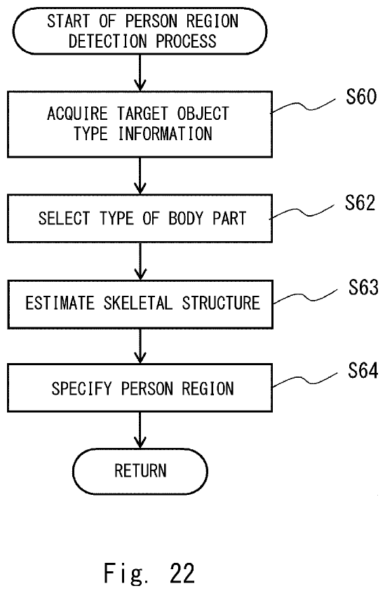

FIG. 22 is a flowchart showing a person region detection process of the first detection unit 701 according to the seventh example embodiment.

First, in Step S60, the body part selection unit 703 of the first detection unit 701 acquires target object type information related to the type of target object through the acquisition unit 200. Note that the acquisition unit 200 may acquire the target object type information by receiving input from a user.

Next, in Step S62, the body part selection unit 703 refers to the body part selection information in the storage unit 711 and selects the type of body part associated with the type of target object.

Then, in Step S63, the skeleton estimation unit 602 of the first detection unit 701 estimates the two-dimensional skeletal structure of a person from the first image I1 by using the skeleton estimation model in the same manner as in Step S50 shown in FIG. 18.

After that, in Step S64, the skeleton estimation unit 602 specifies the person region P on the basis of the estimated two-dimensional skeletal structure and the selected type of body part.

As described above, according to the seventh example embodiment, the image recognition system 70 specifies the person region P on the basis of the type of target object. The image recognition system 70 is thereby capable of more adequately detecting a target object on the basis of the person region P, which further improves the accuracy of recognition.

In the above-described first to seventh example embodiments, the computer is composed of a computer system including a personal computer, a word processor or the like. However, it is not limited thereto, and the computer may be composed of a server of a LAN (Local Area Network), a host of computer (personal computer) communication, a computer system connected on the Internet or the like. Further, a computer may be composed of an entire network by distributing functions among equipment on the network.

Although the present disclosure is described above as a hardware configuration in the first to seventh example embodiments, the present disclosure is not limited thereto. The present disclosure can be implemented by causing a processor 1010, which is described later, to execute a computer program to perform the above-described image recognition process such as person region detection, second image generation, and object region detection.

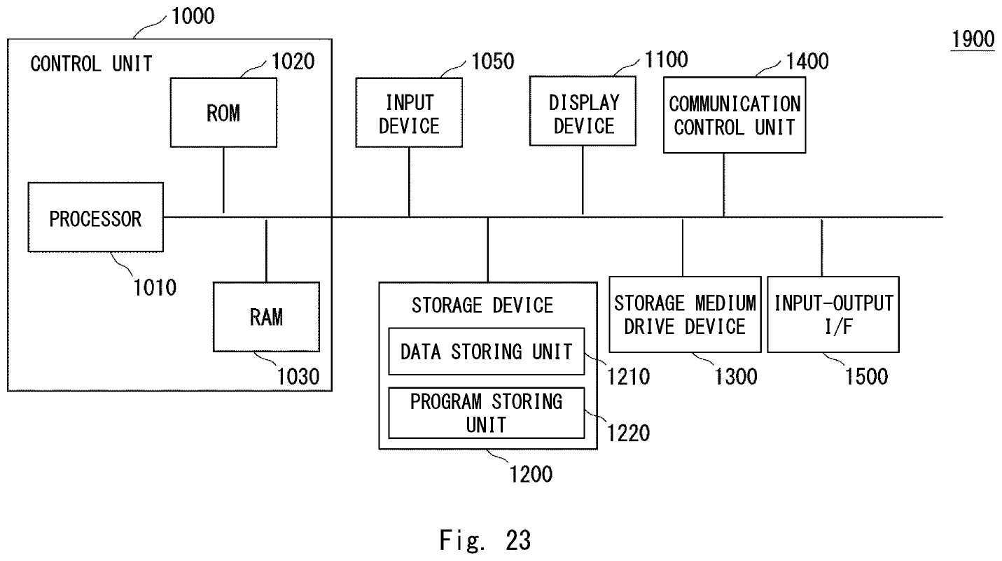

FIG. 23 is an example of a schematic diagram of a computer 1900 according to the first to seventh example embodiments. As shown in FIG. 23, the computer 1900 includes a control unit 1000 for controlling the entire system. An input device 1050, a storage device 1200, a storage medium drive device 1300, a communication control unit 1400, and an input-output I/F 1500 are connected to this control unit 1000 through a bus line such as a data bus.

The control unit 1000 includes a processor 1010, a ROM 1020, and a RAM 1030.

The processor 101 performs various information processing and control according to programs stored in storage units such as the ROM 1020 and the storage device 1200.

The ROM 1020 is a read only memory that previously stores various programs and data for performing various control and operation.

The RAM 1030 is a random access memory that is used as a working memory by the processor 101. In the RAM 1030, areas to perform various processing according to the first to seventh example embodiments are reserved.

The input device 1050 is an input device that receives input from a user, such as a keyboard, a mouse, and a touch panel. For example, the keyboard includes various keys such as a numeric keypad, function keys for executing various functions, and cursor movement keys. The mouse is a pointing device, and it is an input device that specifies a corresponding function by clicking on a key, an icon or the like displayed on a display device 1100. The touch panel is input equipment placed on the surface of the display device 1100, and specifies a user's touch position corresponding to each operation key displayed on the screen of the display device 1100 and receives input of the operation key displayed corresponding to this touch position.

For the display device 1100, a CRT or a liquid crystal display, for example, is used. On this display device, input results by the keyboard or the mouse are displayed, or finally retrieved image information are displayed. Further, the display device 1100 displays images of operation keys for performing necessary operations through a touch panel in accordance with the functions of the computer 1900.

The storage device 1200 is composed of a readable and writable storage medium and a drive unit for reading or writing various types of information such as programs and data in this storage medium.

Although a storage medium used for this storage device 1200 is mainly a hard disk or the like, a non-transitory computer readable medium used for the storage medium drive device 1300, which is described later, may be used.

The storage device 1200 includes a data storing unit 1210, a program storing unit 1220, and another storing unit (for example, a storing unit for backing up programs and data stored in this storage medium 1200), which is not shown, and the like. The program storing unit 1220 stores programs for executing the processing in the first to seventh example embodiments. The data storing unit 1210 stores various types of data of databases according to the first to seventh example embodiments.

The storage medium drive device 1300 is a drive device for the processor 1010 to read a computer program, data containing a document and the like from an outside storage medium (external storage medium).

The external storage medium is a non-transitory computer readable medium in which computer programs, data and the like are stored. Non-transitory computer readable media include any type of tangible storage medium. Examples of the non-transitory computer readable media include magnetic storage media (such as flexible disks, magnetic tapes, hard disk drives, etc.), and optical magnetic storage media (e.g. magneto-optical disks), CD-ROM (Read Only Memory), CD-R, and CD-R/W, semiconductor memories (e.g., mask ROM, PROM (Programmable ROM), EPROM (Erasable PROM), flash ROM, and RAM (Random Access Memory)). The program may be provided to a computer using any type of transitory computer readable medium. Examples of transitory computer readable media include electric signals, optical signals, and electromagnetic waves. The transitory computer readable medium can provide the program to a computer via a wired communication line such as an electric wire or an optical fiber, or a wireless communication line, and the storage medium drive device 1300.

Specifically, in the computer 1900, the processor 1010 of the control unit 1000 reads a program from the external storage medium set by the storage medium drive device 1300 and stores it into the storage device 1200.

The computer 1900 executes processing by loading the relevant program to the RAM 1030 from the storage device 1200. Note that, however, the computer 1900 may execute a program by directly loading the program to the RAM 1030 from an external storage medium by the storage medium drive device 1300, rather than from the storage device 1200. Further, in some computers, a program or the like may be stored in the ROM 1020 in advance, and the processor 1010 may execute it. Further, the computer 1900 may download a program or data from another storage medium through the communication control unit 1400 and execute it.

The communication control unit 1400 is a control device for a network connection of the computer 1900 with an external electronic device such as another personal computer or a word processor. The communication control unit 1400 enables access to the computer 1900 from such an external electronic device.

The input-output I/F 1500 is an interface for connecting input and output devices through a parallel port, a serial port, a keyboard port, a mouse port or the like.

For the processor 1010, CPU (Central Processing Unit), GPU (Graphics Processing Unit), FPGA (field-programmable gate array), DSP (digital signal processor), ASIC (application specific integrated circuit) or the like may be used. Further, a plurality of processors among the above processors may be used in parallel.

Each processing in the system and the method shown in the claims, the specification and the drawings may be performed in any order unless explicitly defined by words such as “before” and “prior to” and unless output of the previous processing is used in the subsequent processing. Even if an operation flow in the claims, the specification and the drawings is described using words such as “first” and “second” for the sake of convenience, this does not mean that the flow needs to be performed in this order.

Although the present disclosure is described above with reference to the example embodiment, the present disclosure is not limited to the above-described example embodiment. Various changes and modifications as would be obvious to one skilled in the art may be made to the structure and the details of the present disclosure without departing from the scope of the disclosure.

### REFERENCE SIGNS LIST

10,20,30,40,50,60,70 IMAGE RECOGNITION SYSTEM

101,201,601,701 FIRST DETECTION UNIT

104,204,304,404 EXTRACTED IMAGE GENERATION UNIT

107,207,507 SECOND DETECTION UNIT

200 ACQUISITION UNIT

211,711 STORAGE UNIT

305 SIZE DECISION UNIT

406 DETERMINATION UNIT

508 CANDIDATE REGION DETECTION UNIT

509 SPECIFYING UNIT

602 SKELETON ESTIMATION UNIT

703 BODY PART SELECTION UNIT

I1 FIRST IMAGE

12 SECOND IMAGE

P PERSON REGION

A EXTRACTED REGION

1000 CONTROL UNIT

1010 PROCESSOR

1020 ROM

1030 RAM

1050 INPUT DEVICE

1100 DISPLAY DEVICE

1200 STORAGE DEVICE

1210 DATA STORING UNIT

1220 PROGRAM STORING UNIT

1300 STORAGE MEDIUM DRIVE DEVICE

1400 COMMUNICATION CONTROL UNIT

1500 INPUT-OUTPUT I/F

1900 COMPUTER

What is claimed is:

1. An image recognition system comprising:
at least one memory storing instructions, and
at least one processor configured to execute the instructions to;
detect a person region showing at least part of a body of a person from a first image where a target object related to the person is captured;
cut out, from the first image, an extracted region defined according to the person region; and
detect the target object on the basis of the cutout extracted region.

2. The image recognition system according to claim 1, wherein
the at least one processor is to generate a second image on the basis of the extracted region, and
detect, from the second image, an object region which is an image region showing the target object.

3. The image recognition system according to claim 2, wherein the at least one processor is to decide the number of pixels of the second image on the basis of the number of pixels of the extracted region.

4. The image recognition system according to claim 2, wherein the at least one processor is to determine whether to generate the second image on the basis of the number of pixels of the person region.

5. The image recognition system according to claim 2, wherein the at least one processor is to:
detect, from the second image, one or a plurality of candidate regions which is/are an image region(s) likely to show the target object; and
specify the object region from the one or the plurality of candidate regions on the basis of information on the position(s) of the one or the plurality of candidate regions relative to the person region.

6. The image recognition system according to claim 2,
wherein the at least one processor is to display the second image.

7. The image recognition system according to claim 1,
the person region shows a body part of the person, and
the at least one processor is to estimate a two-dimensional skeletal structure of the person and detect detects the person region on the basis of the estimated two-dimensional skeletal structure.

8. The image recognition system according to claim 1, wherein
the person region shows a body part of the person, and
the at least one processor is to select a type of the body part on the basis of a type of the target object.

9. An image recognition method comprising:
detecting a person region showing at least part of a body of a person from a first image where a target object related to the person is captured;
cutting out, from the first image, an extracted region defined according to the person region; and
detecting the target object on the basis of the cutout extracted region.

10. A non-transitory computer readable medium storing an image recognition program causing a computer to execute an image recognition method comprising:
detecting a person region showing at least part of a body of a person from a first image where a target object related to the person is captured;
cutting out, from the first image, an extracted region defined according to the person region; and
detecting the target object on the basis of the cutout extracted region.
